(19) United States
(12) Patent Application Publication
(10) Pub. No.: US 2026/0269708 A1
(43) Pub. Date: Sep. 10, 2026

(54) BIDIRECTIONAL SPLIT-PHASE POWER CONVERTER FOR ELECTRIC VEHICLE CHARGING

(71) Applicant: dcbel Inc., Montréal (CA)

(72) Inventors: Ernest Montllo Casabayo, Montréal (CA); Paulo Barroso, Brossard (CA); Reza Hesaraki, Montréal (CA)

(21) Appl. No.: 19/403,175

(22) Filed: Nov. 27, 2025

Related U.S. Application Data
(63) Continuation-in-part of application No. 19/324,953, filed on Sep. 10, 2025, now Pat. No. 12,565,111.
(60) Provisional application No. 63/767,062, filed on Mar. 5, 2025.

(51) Int. Cl. B60L 55/00; B60L 58/19; H02J 7/00; H02J 7/02; H02J 7/34; H02M 1/00; H02M 3/335

(52) U.S. Cl. CPC H02M 1/008; B60L 55/00; B60L 58/19; H02J 7/02; H02J 7/34; H02J 7/40; H02J 7/855; H02J 7/90; H02M 3/33584; B60L 2210/10; B60L 2210/30; H02J 2207/20

(57) ABSTRACT

A battery charger capable of receiving AC power and delivering DC power to an electric power storage battery is adapted to operate with high-frequency isolation transformer on the DC side with two secondary coils and two DC outputs that can be used for lower voltage charging or higher voltage charging.

This patent application is a continuation-in-part of U.S. patent application Ser. No. 19/324,953, now pending, filed Sep. 10, 2025, that claims priority of U.S. provisional patent application 63/767,062, filed on Mar. 5, 2025, the contents of which are hereby incorporated by reference.

### TECHNICAL FIELD

The present disclosure relates generally to the field of electrical power converters and more specifically to converters providing galvanic isolation.

### BACKGROUND

This section intends to provide a background or context to the invention recited in the claims. The description herein may include concepts that could be pursued but are not necessarily ones that have been previously conceived or pursued. Therefore, unless otherwise indicated herein, what is described in this section is not prior art to the description and claims in this application and is not admitted as being prior art by inclusion in this section.

DC chargers for electric vehicles (EVs) typically use an isolation transformer to receive grid power and provide electrical power that is not referenced to ground. While this makes the charging power safe against a ground fault, such EV chargers are larger and more expensive than non-isolated solutions.

In the case of a bidirectional EV charger for home use, an advantage of using an isolation transformer is that, in the case of split-phase AC grids, a single-phase AC-to-DC power converter can provide AC power from the EV to the home on either or both of the split-phase lines which is necessary when providing power during a blackout situation (Vehicle to Home or V2H) such that no grid transformer can provide the balancing. There is currently no suitable bidirectional EV charger that avoids an isolation transformer and is suitable for use with split-phase home power grids.

### SUMMARY

The Applicant has found an apparatus for providing bidirectional isolated power conversion for different types of current in the context of split-phase that has high efficiency and can be implemented using a small transformer.

In one broad aspect of current invention, a bidirectional power converter for converting electric power between an AC power grid and an electric vehicle (EV) may comprise: (1) at least one AC-to-DC power converter, which may have an AC port and a DC side port; (2) an isolated DC-to-DC power converter, which may be connected on a first side to the DC side port of the at least one AC-to-DC power converter and on a second side to a first and a second pair of DC terminals, wherein the at least one isolated DC-to-DC power converter may comprise: (i) an isolation transformer, which may have a primary winding and two secondary windings; (ii) a DC to high-frequency AC converter, which may be connected to the DC side of the at least one AC-to-DC power converter and to the primary winding of the isolation transformer on an AC side; (iii) a first high-frequency AC to DC converter, which may be connected to a first one of the two secondary windings on the AC side and to the first pair of DC terminals on the DC side; and (iv) a second high-frequency AC to DC converter, which may be connected to a second one of the two secondary windings on the AC side and to the second pair of DC terminals on the DC side; and (3) a power conversion controller, which may have an interface for receiving a charge command from a battery management system (BMS) of an electric power storage battery of the EV, a grid tie phase and a voltage measurement. Furthermore, the power conversion controller may be operatively connected to the at least one AC-to-DC power converter and to the isolated DC-to-DC power converter for transferring power in accordance with the charge voltage command, the grid tie phase and the voltage measurement.

In some embodiments, the at least one AC-to-DC power converter of the bidirectional power converter may comprise a first AC-to-DC power converter and a second AC-to-DC power converter, wherein the AC side port of the first AC-to-DC power converter and the AC side port of the second AC-to-DC power converter may be connected to a respective phase of the AC power grid and connected together at a midpoint or neutral.

In some embodiments, the bidirectional power converter may further comprise at least one first switch for connecting the first pair of DC terminals and the second pair of DC terminals in series for providing a single high-voltage DC EV connection; and a plurality of second switches for connecting the first pair of DC terminals and the second pair of DC terminals in parallel for providing a low-voltage DC EV connection.

In some embodiments, plurality of second switches of the bidirectional power converter may be arranged to selectively connect to one of two EVs for providing a low-voltage DC connection to one EV, or to two EVs for providing a low-voltage DC connection to two EVs.

In some embodiments, at least one first switch and the plurality of second switches of the bidirectional power converter may be controlled by the power conversion controller with respect to the charge voltage command of the BMS of the electric power storage battery for providing a controlled DC output to the EV connection.

In some embodiments, the respective phase may comprise a first AC output and a second AC output that are 180 degrees out of phase, wherein the first AC output is connected to the AC port of the first AC-to-DC power converter, and the second AC output is connected to the AC port of the second AC-to-DC power converter.

In some embodiments, the high-voltage DC output of the bidirectional power converter may be between 600 V DC and 1000 V DC.

In some embodiments, the low-voltage DC output of the bidirectional power converter may be preferably between 300 V DC and 500 V DC.

In another broad aspect of current invention, an electric vehicle (EV) charger may comprise an isolated DC-to-DC power converter connected on a first side to the DC side port of the at least one AC-to-DC power converter and on a second side to a first and a second pair of DC terminals. The isolated DC-to-DC power converter may comprise: (i) an isolation transformer, which may have a primary winding and two secondary windings; (ii) a DC to high-frequency AC converter, which may be connected to the DC side of the at least one AC-to-DC power converter and to the primary winding of the isolation transformer on an AC side; (iii) a first high-frequency AC to DC converter, which may be connected to a first one of the two secondary windings on the AC side and to the first pair of DC terminals on the DC side; and (iv) a second high-frequency AC to DC converter, which may be connected to a second one of the two secondary windings on the AC side and to the second pair of DC terminals on the DC side. Furthermore, an EV charger may comprise a power conversion controller having an interface for receiving a charge command from a battery management system (BMS) of an electric power storage battery of the EV. The power conversion controller may be operatively connected to the isolated DC-to-DC power converter for transferring power in accordance with the charge command.

In some embodiments, the EV charger may further comprise at least one first switch for connecting the first pair of DC terminals and the second pair of DC terminals in series for providing a single high-voltage DC EV connection; and a plurality of second switches for connecting the first pair of DC terminals and the second pair of DC terminals in parallel for providing a low-voltage DC EV connection.

In some embodiments, the plurality of second switches of the EV charger may be arranged to selectively connect to one of two EVs for providing a low-voltage DC connection to one EV, or to two EVs for providing a low-voltage DC connection to two EVs.

### BRIEF DESCRIPTION OF THE DRAWINGS

The present examples will be better understood with reference to the appended illustrations, which are as follows:

FIG. 1 is a schematic block diagram of an isolated EV charger, which is known in the art and uses an isolation transformer between the grid and the power converter;

FIG. 2A is a schematic block diagram of an isolated EV charger (also referred to as a bidirectional power converter) having an EMI filter connected to split-phase mains power and an isolated DC-to-DC power converter in accordance with an embodiment of the present invention;

FIG. 2B is a schematic block diagram providing a detailed view of an isolated EV charger illustrated in FIG. 2A, having a high-frequency isolation transformer in the DC-to-DC power conversion stage in accordance with an embodiment of the present invention;

FIG. 2C schematically illustrates a partial view of an alternative embodiment of the bidirectional power converter shown in FIG. 2B; in this example, an isolated DC-to-DC power converter may comprise two EV cable connections for delivering or drawing power from two EV batteries simultaneously;

FIG. 2D schematically illustrates a detailed view of the isolated DC-to-DC power converter, which may be connected to one EV battery, as shown in FIG. 2B;

FIG. 2E schematically illustrates a detailed view of the isolated DC-to-DC power converter, which may be connected to two EV batteries, as shown in FIG. 2C;

FIG. 3 is a schematic illustration of the grid protection components provided in FIG. 2B;

FIG. 4 is a schematic illustration of a dual-stage EMI filter;

FIG. 5 is a schematic illustration of a part of the AC-to-DC converter comprising AC relays and the AC-to-DC LCL filter;

FIG. 6 schematically illustrates the AC-to-DC synthesizer converter, which may comprise two AC-to-DC power converters; FIG. 6 also schematically illustrates the DC link and bus capacitors;

FIG. 7A schematically illustrates a triple-active-bridge (TAB) DC-to-DC power converter, which may comprise a DC to high-frequency AC converter, an isolation transformer, and two high-frequency AC to DC converters, i.e., a first high-frequency AC to DC converter, and a second high-frequency AC to DC converter that can either be connected in series or parallel depending on the voltage range of the EV Battery;

FIG. 7B schematically illustrates an alternative embodiment of DC-to-DC power converter shown in FIG. 7A, which allows a parallel series connection as well as being able to charge multiple EVs at the same time or transfer energy from one to another.

FIG. 7C schematically illustrates another alternative embodiment DC-to-DC power converter shown in FIG. 7A, which may have a single DC to high-frequency AC converter, an isolation transformer, and a single high-frequency AC to DC converter;

FIG. 8 schematically illustrates an EV DC circuit, which may comprise an electromagnetic interference (EMI) filter, a protection circuit and a pre-charge circuit, which may be directly connected to the battery of an EV at EV battery terminals;

FIG. 9 schematically illustrates a photovoltaic (PV) electromagnetic compatibility (EMC) and protection circuit, which may comprise an electromagnetic interference (EMI) filter, a protection circuit and a pre-charge circuit, wherein an output of at least one PV panel or a plurality of PV panels may be provided to the DC link and bus capacitors;

FIG. 10 schematically illustrates a third energy storage system (ESS) DC-to-DC power converter, which may be connected to an external storage battery using a battery energy storage system (BESS) protection and pre-charge circuit;

FIG. 11 schematically illustrates a BESS EMC, protection and pre-charge circuit, which may comprise an electromagnetic interference (EMI) filter, a pre-charge circuit and a protection circuit, which may be connected to the terminals of an external storage battery.

### DETAILED DESCRIPTION

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

Reference throughout this application to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the scope of the invention. Thus, it is intended that the present description covers the modifications and variations of the present invention and may then come within a scope of the appended claims and their equivalents. Reference will now be made in detail to the preferred embodiments of the invention.

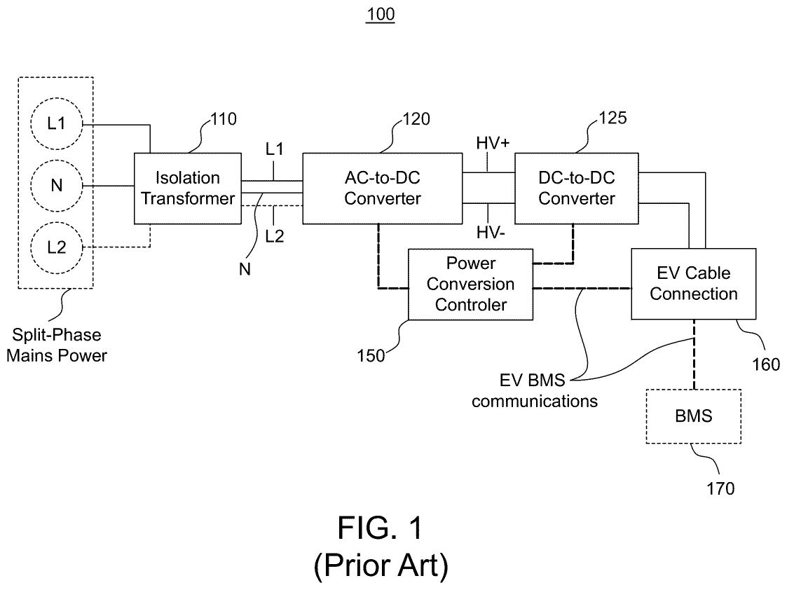

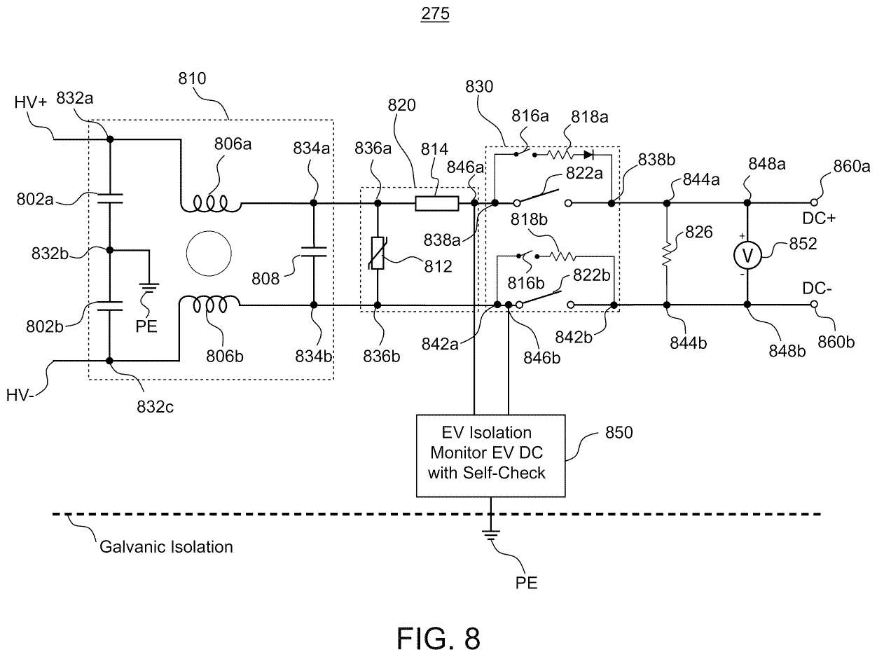

FIG. 1 schematically illustrates bidirectional power converter 100 of a bidirectional EV charger known in the prior art comprising a split-phase AC input from the split-phase mains power, including three terminals, namely, terminals L1 and L2 for two live (“hot”) wires each carrying 120 V, with their associated AC signals being 180 degrees out of space, as well as the neutral terminal N. When EV charger operates in the rectifier mode, the AC input provided by split-phase mains may be connected to an isolation transformer 110 that guarantees galvanic isolation and, as a result, protects a user from an electric shock. Isolation transformer 110 may be further connected to an AC-to-DC power converter 120, wherein the output of the latter may further be supplied to a DC-to-DC power converter 125. The output of DC-to-DC power converter 125 may then be supplied to EV terminals (see EV terminals 860a and 860b shown in FIG. 8 for the positive and negative DC input/output, respectively) configured to be connected to an electric power storage battery of an electric vehicle (EV) through EV cable connection 160. Both, AC-to-DC converter 120 and DC-to-DC power converter 125 may be operated using a power conversion controller 150. It may be appreciated by the person skilled in the art that the battery management system (BMS) 170 may communicate with power conversion controller 150 via EV cable connection 160 in order to transmit the information about current charge level and a desired charge voltage for charging the EV battery, i.e., a power conversion controller may have an interface for receiving a charge voltage command from BMS 170, including a desired charge voltage value of an EV, a grid tie phase, and a voltage measurement providing an amount of available voltage value that could be supplied to the battery of an EV. It may be appreciated that if power conversion controller 150 may be located on board of an EV, and EV cable connection 160 may be internal to an EV.

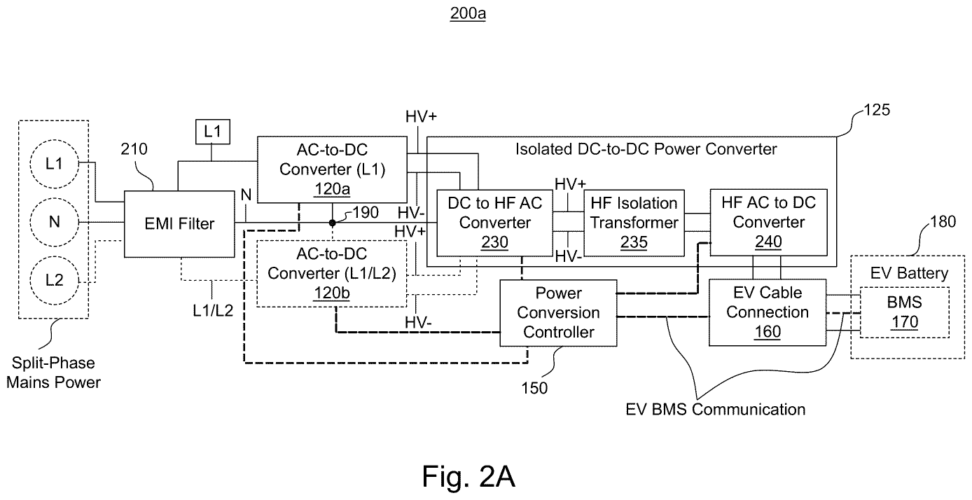

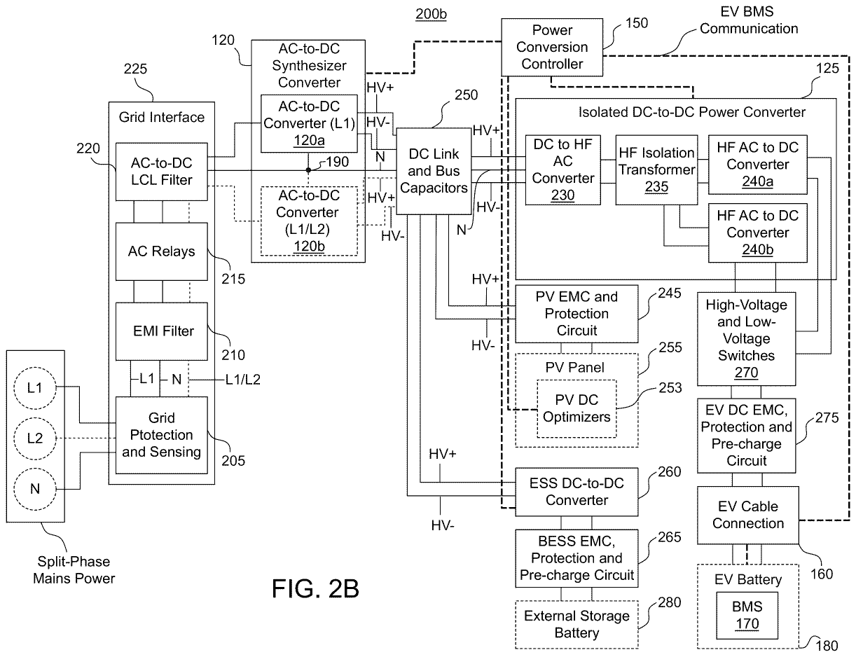

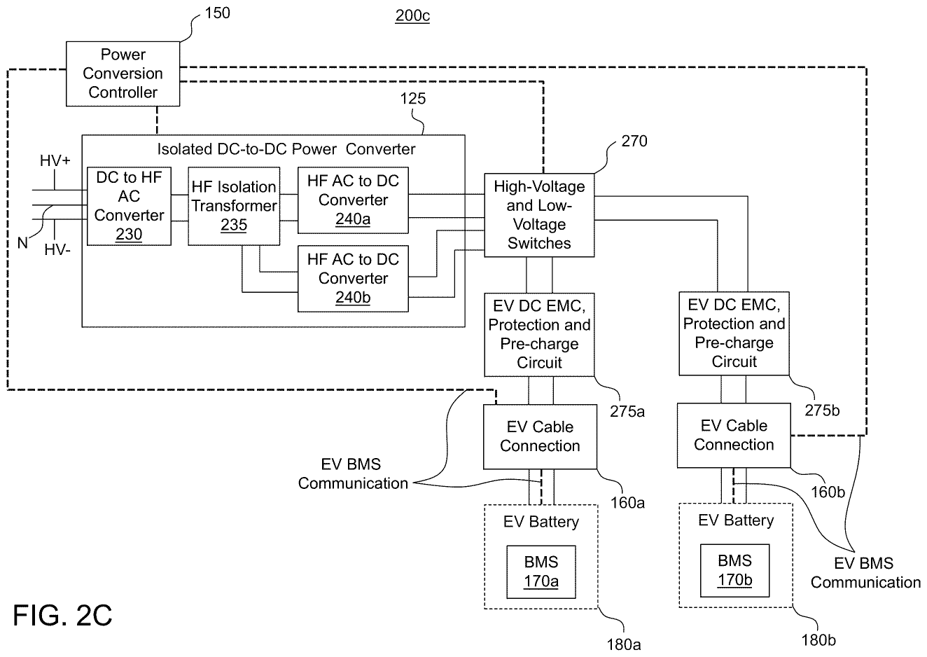

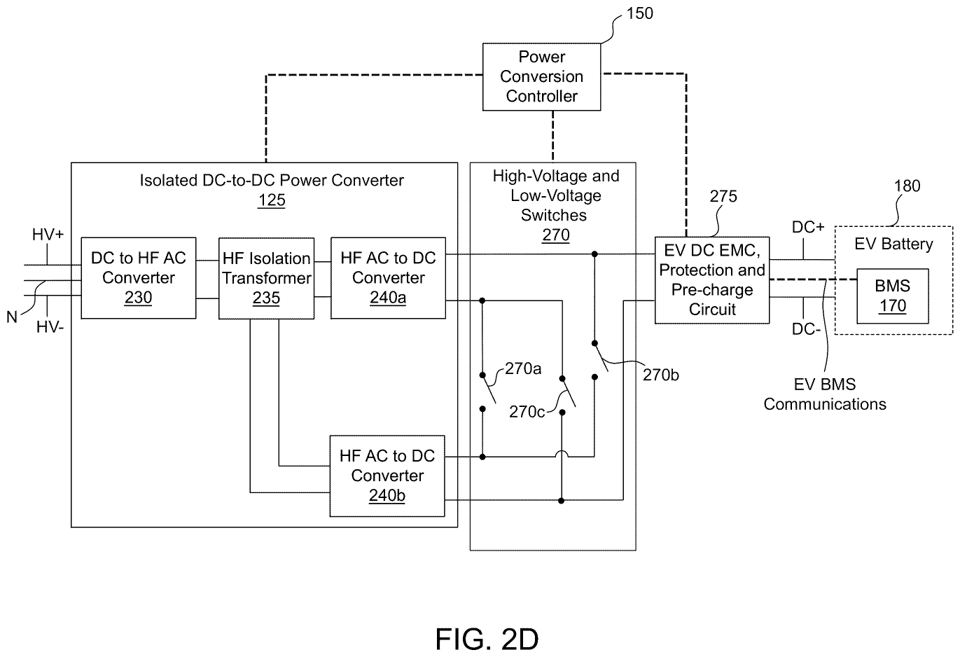

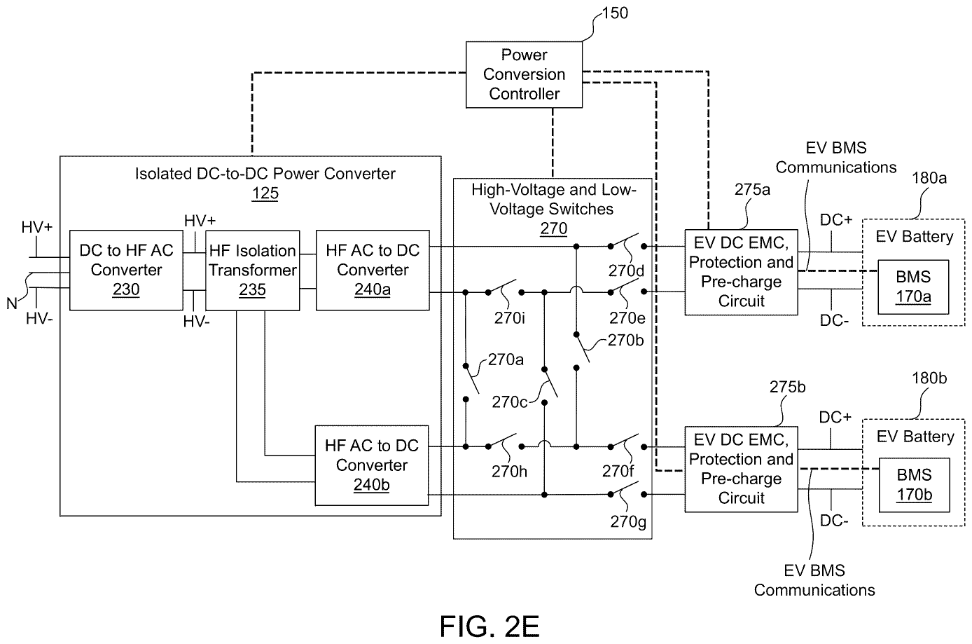

FIG. 2A schematically illustrates simplified block diagram depicting bidirectional power converter 200a provided in the context of this embodiment, in which an EV may be charged DC charged using an off-board charger connected directly to split-phase AC mains power, without the use of isolation transformer 110 coupled to AC mains as illustrated in FIG. 1. In this example, an EV charger may operate in the rectifier mode, and, therefore, AC power, which may be supplied from terminals L1 and L2, may first be passed through EMI filter 210. It may be appreciated that EMI filter 210 may receive AC power from only L1 or L2, in case if only a single-phase connection is available. It may further be appreciated that EMI filter 210 may be provided by but is not limited to a dual-stage EMI filter, which may help to minimize radiated and conducted noise, mitigate voltage transients from the input of the AC mains, and therefore offer a higher level of noise attenuation. The output of EMI filter 210 associated with L1 and L2 may then be provided to AC-to-DC converters 120a and 120b, respectively. It may be appreciated that AC-to-DC converters 120a and 120b may be connected at midpoint (or neutral) 190. Furthermore, the output of AC-to-DC converters 120a and 120b may then be supplied to isolated DC-to-DC power converter 125, which may comprise DC to high-frequency AC converter 230, isolation transformer 235, which may be provided by a high-frequency isolation transformer, and high-frequency AC to DC converter 240. When bidirectional power converter 200a operates in a rectifier mode, power conversion controller 150 may receive a charge voltage command from BMS 170 associated with EV battery 180 through EV cable connection 160 and may respond to that command by producing a suitable DC voltage output. However, it may be appreciated that, when bidirectional power converter 200a operates in the inverter mode, it may produce an AC current respecting desired grid tie phase and output AC current to a respective phase of AC power grid. It may also be appreciated that when bidirectional power converter 200a operates in an inverter mode, a second power conversion controller 150 may be required.

FIG. 2B schematically illustrates a preferred embodiment of bidirectional power converter 200a, i.e., bidirectional power converter 200b. It may be appreciated that, when bidirectional power converter 200b operates as a rectifier, before reaching EMI filter 210, the AC power from split-phase mains power supply, i.e., from L1 and L2 terminals, may first pass through grid protection and sensing stage 205. When charging an EV battery or supplying AC power back to the grid, AC relays 215 may be closed, allowing the AC power to flow through AC-to-DC LCL filter 220, and then be supplied to AC-to-DC synthesizer converter 120, which may comprise two AC-to-DC power converters 120a, 120b. It may be appreciated that AC-to-DC converters 120a and 120b may be connected at midpoint (or neutral) 190. It may also be appreciated that grid protection and sensing stage 205, EMI filter 210, AC relays 215, and AC-to-DC LCL filter 220 may constitute a part of grid interface 225. It may be appreciated that, for the purpose of illustration, the communication between power conversion controller 150, BMS 170, AC-to-DC synthesizer converter 120, isolated DC-to-DC power converter 125, and PV DC optimizers 253 is provided by dashed connectors.

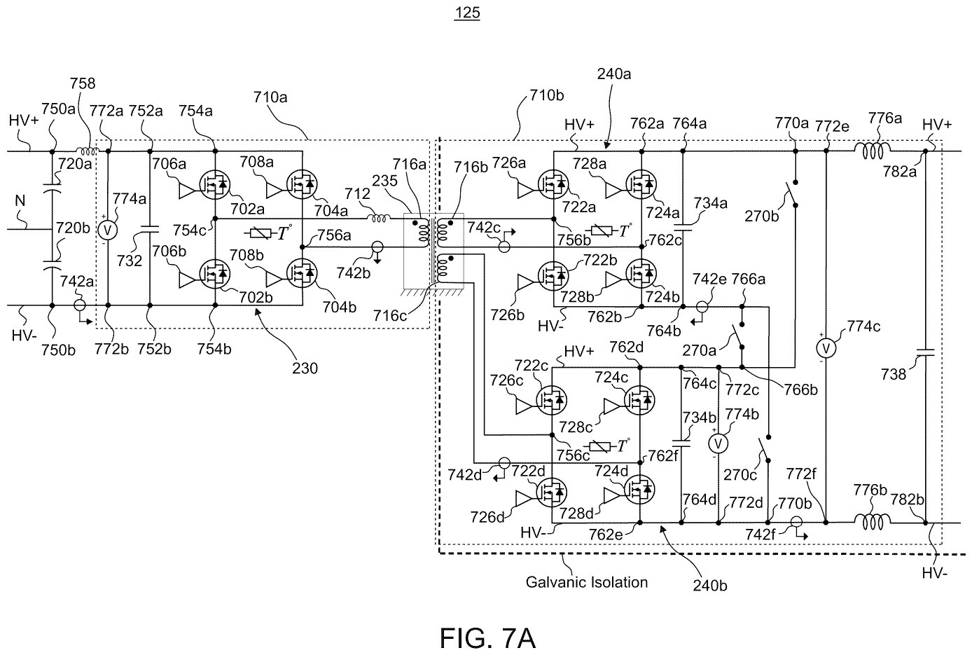

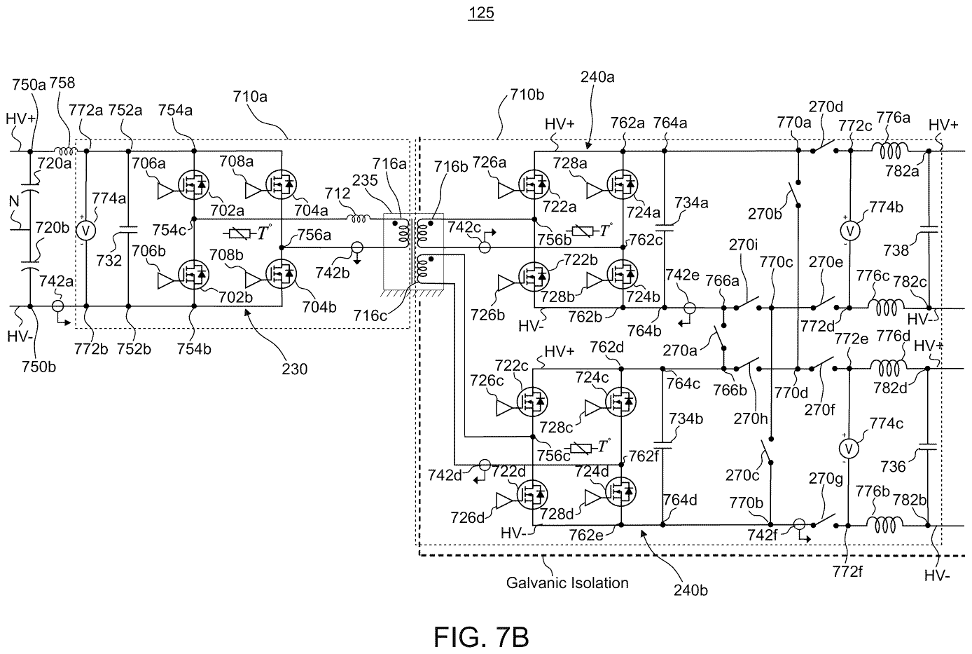

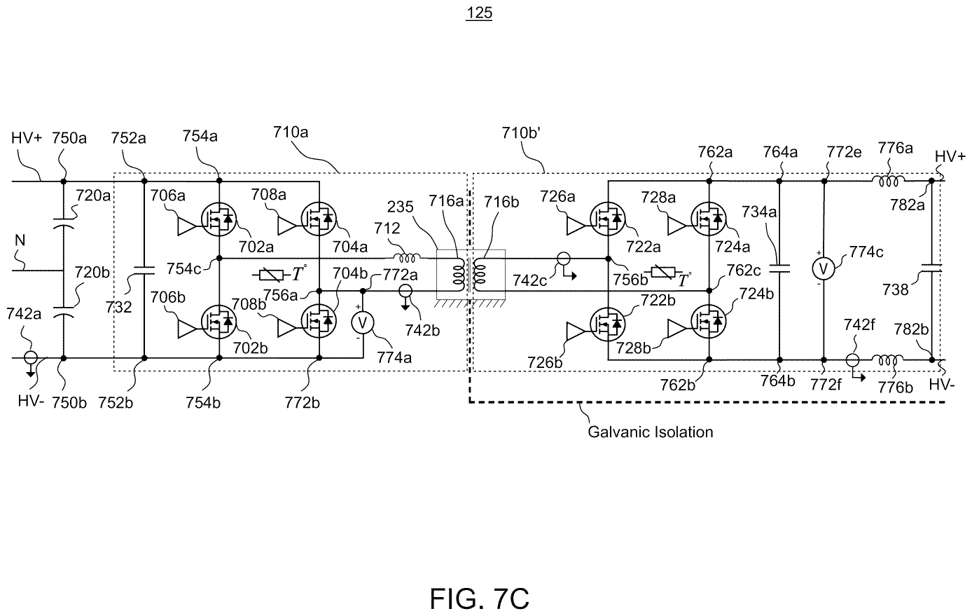

As further illustrated in FIG. 2B, when bidirectional power converter 200b operates as a rectifier, the output of the AC-to-DC converters 120a and 120b may further be used to charge DC link and bus capacitors 250 (further referred to as DC bus capacitors 250), which may further be connected to at least one isolated DC-to-DC-converter 125. It may be appreciated that, in this example, DC-to-DC-converter 125 may be provided by, but is not limited to, a 3-level dual active bridge (DAB) converter. It may also be appreciated that high-frequency AC to DC converter 240 may comprise first high-frequency AC to DC converter 240a and second high-frequency AC to DC converter 240b. Furthermore, high-frequency isolation transformer 235 may comprise one primary winding (see primary winding 716a in FIG. 7A), which may be connected to the AC side of DC to high-frequency AC converter 230, and two secondary windings, wherein a first secondary winding may be connected to the AC side of first high-frequency AC to DC converter 240a (see first secondary winding 716b in FIG. 7A) and second secondary winding may be connected to the AC side of second high-frequency AC to DC converter 240b (see second secondary winding 716c in FIG. 7A). It may further be appreciated that first high-frequency AC to DC converter 240a and second high-frequency AC to DC converter 240b on their DC side may further be connected to EV DC EMC, protection and pre-charge circuit 275 using high-voltage and low-voltage switches 270. It may be appreciated that, in one embodiment, high-voltage and low-voltage switches 270 may be a part of isolated DC-to-DC power converter 125.

It may be appreciated that a photovoltaic (PV) system may comprise a PV panel array 255, each of which may include PV DC power optimizers 253 allowing for power conversion control of each individual panel or groups of panels within the array.

It may further be appreciated that PV panel array 255, or at least one storage battery 280, or both, may be connected to DC bus capacitors 250. It may also be appreciated that a PV electromagnetic compatibility (EMC), protection and pre-charge circuit 245 may be connected to DC bus capacitors 250 and the output of at least one PV panel 255. Furthermore, battery energy storage system (BESS) EMC, protection and pre-charge circuit 265 may be connected to the positive and negative DC terminals of storage battery 280. Moreover, third energy storage system (ESS) DC-to-DC power converter 260 may be connected between DC bus capacitors 250 and BESS EMC, protection and pre-charge circuit 265, in order to, for example, bring DC bus capacitors 250 to a desired voltage level. It may be appreciated that an EV is connected to bidirectional power converter 200b, DC power from at least one PV panel, for example, may be supplied to storage battery 280 or split-phase mains power.

It may be appreciated by the person skilled in the art that EV DC EMC, protection and pre-charge circuit 275 may be connected to second high-frequency AC to DC converter of isolated DC-to-DC power converter 125 on the DC side, for ensuring safe operation during the EV connection process and preventing large inrush current which may damage the EV battery, when an EV charger operates in rectifier mode.

FIG. 2C schematically illustrates a partial block-diagram of an alternative embodiment of bidirectional power converter 200b, i.e., bidirectional power converter 200c, which may allow for simultaneous charging or discharging of two EV batteries. It may be appreciated the other components of bidirectional power converter 200c may correspond to those provided for bidirectional power converter 200b in FIG. 2B. In this example, first high-frequency AC to DC converter 240a may be further connected to EV battery 180a, and second high-frequency AC to DC converter 240b may be further connected to EV battery 180b. Thus, it may be appreciated that each one of the first and second high-frequency AC to DC converters 240a and 240b may be connected to a corresponding EV DC EMC protection and pre-charge circuit 275a/275b, which may then be connected to a corresponding EV battery 180a/180b through cable connection 160a/160b, respectively. In this embodiment, bidirectional power converter 200c may be used to either simultaneously or alternatingly charge or discharge EV batteries 180a and 180b as further explained using FIG. 2E.

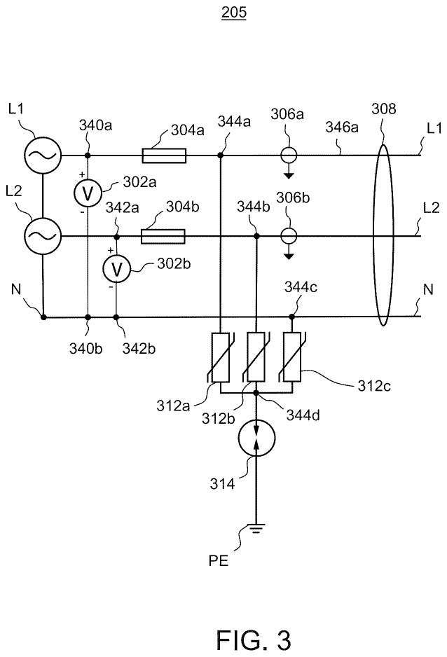

It may also be appreciated that while bidirectional power converter 200b, schematically illustrated in FIG. 2B, may be adapted for a split-phase system, which is common in North America, Japan, and Taiwan. However, it may also be configured to connect to a single-phase power supply, which is common in Europe, Australia, South Korea, and other Asian countries. Thus, in an alternative embodiment, bidirectional power converter 200b, instead of being connected to L1, L2 and neutral N, may only be connected, for example, to L1, which may represent a single phase of 230V/240V, and neutral N, which may be grounded to establish a 0 V reference. It may be appreciated that, in a single-phase design, bidirectional power converter 200b may comprise at least one AC-to-DC converter (e.g., a single phase L1 may be connected to only AC-to-DC converter 120a, or may also simultaneously be connected to AC-to-DC converter 120b) and the components of grid interface 225 may be adapted to accommodate a single-phase only. By adjusting power conversion controller 150, it may be possible to connect both converters 120a, 120b in parallel for a single phase, doing so in a way that could reduce the output current ripple for better total harmonic distortion by delaying the switching of each of the converters by 180 degrees. For example, as further illustrated in FIGS. 3 to 6, the person skilled in the art would also appreciate that the circuit components of bidirectional power converter 200b associated with the L2 line may be removed to allow for a single-phase design, or, when AC-to-DC power converter 120b may be connected to L1, the corresponding circuit components may be kept.

It may further be appreciated by a person skilled in the art that a single-phase design may also be used in North America, when, for example, bidirectional power converter 200b operates in vehicle-to-grid (V2G) mode and outputs about 240V AC to the grid. However, when bidirectional power converter 200b operates in for vehicle-to-home (V2H) mode, a single-phase configuration may only allow to deliver power to high-wattage appliances and loads like electric ovens, clothes dryers, electric water heaters, etc., which require 220V/240V to operate, but may not be able to supply small appliances which require 110V/120V. Therefore, in North America, a split-phase configuration of bidirectional power converter 200b may be required to enable V2H mode, whereas in Europe, small appliances require 220V/240V, and therefore, a single-phase design enables both V2G and V2H operation of bidirectional power converter 200b.

Furthermore, it may be appreciated that in countries (e.g., Germany, Finland, Denmark, Norway, etc.), where users can draw power from three phases, a person skilled in the art would appreciate that bidirectional power converter 200b schematically illustrated in FIG. 2B may then either draw power from one phase only or may include third AC to DC power converter (same as the AC-to-DC converters 120a and 120b) to be connected to the third phase (i.e., L3 terminal), so that AC-to-DC power converter 120 may be capable of drawing power from the three phases.

FIG. 2D schematically illustrates isolated DC-to-DC power converter 125 of bidirectional power converter 200b shown in FIG. 2B, which may be connected to one EV battery 180. It may be appreciated that the connection between isolated DC-to-DC power converter 125 and EV battery 180 may be established using high-voltage and low-voltage switches 270. It may also be appreciated that first switch 270a (i.e., a high-voltage switch) may be used connect high-frequency AC to DC converter 240a and high-frequency AC to DC converter 240b in series, which may allow, for example, to achieve a high-voltage DC voltage output, while keeping lower current value, when bidirectional power converter 200b is operating as an active rectifier, which would result in a faster charging of EV battery 180. For example, when each one of high-frequency AC to DC converters 240a and 240b may be capable of outputting up to 400 V DC at the maximum current value of 20 A, and EV cable connection 160 is, for example, rated for a maximum of 30 A, then connecting them in series would allow to output up to 800 V×20 A=16 kW into EV battery 180. Therefore, a person skilled in the art would appreciate that keeping lower current, while increasing the voltage, would allow for having a thinner charging cable (e.g., in EV cable connection 160, which may be advantageous for users, as, for example, charging cables capable of carrying 100 A current may be bulky, heavy and costly).

Furthermore, a plurality of second switches 270b and 270c (i.e., low-voltage switches) may be used to connect first high-frequency AC to DC converter 240a and second high-frequency AC to DC converter 240b in parallel, which would result in a low-voltage DC output. It may be appreciated that, in this description, the term “low-voltage DC output” may be used to differentiate from “high-voltage DC output”; however low-voltage DC output may simply be a bit lower than the high-voltage DC output, and the maximum value of low-voltage DC output may be dictated by voltage rating of corresponding high-frequency AC to DC converter 240a/240b. For example, when each one of high-frequency AC to DC converters 240a and 240b may be capable of outputting up to 400 V DC at the maximum current value of 20 A, and EV cable connection 160 is, for example, rated for 30 A, then connecting first and second high-frequency AC to DC converters 240a and 240b in parallel would allow to output up to 400 V×30 A=12 kW into EV battery 180 (as, in this example, the maximum amount of electrical current, which can be carried by EV cable connection 160 may not exceed 30 A, thus EV cable connection 160 would not be able to carry 40 A without overheating). Therefore, connecting first and second high-frequency AC to DC converters 240a and 240b in parallel may result in a slower charging of EV battery 180 comparatively to when first and second high-frequency AC to DC converters 240a and 240b are connected in series. This may be advantageous, for example, when a user would prefer to charge their EV battery overnight or during peak usage hours while still benefitting from having relatively thin EV cable connection 160.

FIG. 2E further schematically illustrates isolated DC-to-DC power converter 125 of bidirectional power converter 200c shown in FIG. 2C, which may be configured to simultaneously connect to two EV batteries, i.e., first EV battery 180a and second EV battery 180b. The connection between isolated DC-to-DC power converter 125 and first EV battery 180a, or second EV battery 180b, or both, may be established using high-voltage and low-voltage switches 270. It may be appreciated that first switch 270a may be used connect first high-frequency AC to DC converter 240a and second high-frequency AC to DC converter 240b in series, and a plurality of second switches 270b and 270c may be used to connect high-frequency AC to DC converter 240a and high-frequency AC to DC converter 240b in parallel. Furthermore, closing a plurality of third switches 270d and 270e (i.e., high-voltage switches), or closing a plurality of fourth switches 270f and 270g (i.e., high-voltage switches), would allow to either charge EV battery 180a or EV battery 180b at a time, respectively, at a higher or lower speed, in a similar manner as discussed above for the arrangement illustrated in FIG. 2D.

However, it may be appreciated that, in this example, connecting first high-frequency AC to DC converter 240a and second high-frequency AC to DC converter 240b in series may further involve: i) closing switch 270i to connect first and second high-frequency AC to DC converters 240a, 240b to EV battery 180a, or ii) closing switch 270h to connect first and second high-frequency AC to DC converters 240a, 240b to EV battery 180b, which may allow to charge either EV battery 180a or EV battery 180b with high-voltage DC, respectively, when bidirectional power converter 200c operates as a rectifier. It may be appreciated that switch 270i may constitute a part of third switches, and switch 270h may constitute a part of fourth switches.

Therefore, a person skilled in the art may appreciate that to provide power to first EV battery 180a, when first and second high-frequency AC to DC converters 240a and 240b may be connected in series, power conversion controller 150 may issue a command to close switches 270a, 270c, 270d and 270e, while switches 270b, 270i, 270h, 270f, and 270g may remain open. Similarly, to provide power to second EV battery 180b, when first and second high-frequency AC to DC converters 240a and 240b may be connected in series, power conversion controller 150 may issue a command to close switches 270a, 270b, 270f, and 270g, while switches 270c, 270i, 270h, 270d, and 270e may remain open.

Furthermore, to charge first EV battery 180a, when first and second high-frequency AC to DC converters 240a and 240b may be connected in parallel, power conversion controller 150 may issue a command to close switches 270i, 270b, 270c, 270d, and 270e, while switches 270a, 270h, 270f, and 270g may remain open. Also, it may be appreciated that to charge second EV battery 180b, when first and second high-frequency AC to DC converters 240a and 240b may be connected in parallel, power conversion controller 150 may issue a command to close switches 270h, 270b, 270c, 270f, and 270g, while switches 270a, 270i, 270d, and 270e may remain open.

Furthermore, leaving switches 270a, 270b, and 270c open, and at the same time closing third switches 270d, 270e, and 270i, and closing fourth switches 270f, 270g, and 270h would allow to charge first and second EV batteries 180a and 180b simultaneously (i.e., by providing a first low-voltage DC output from first high-frequency AC-to-DC converter 240a to first EV battery 180a, and a second low-voltage DC output from second high-frequency AC-to-DC converter 240b to the second EV battery 180b). For example, if each one of first and second high-frequency AC to DC converters 240a and 240b may be capable of outputting up to 400 V DC at the maximum current value of 20 A, and each EV cable connection 160a and 160b is, for example, rated for 30 A, then each one of high-frequency AC to DC converters 240a and 240b would allow to output up to 400 V×20 A=8 kW to a corresponding EV battery 180a and 180b, respectively.

It may be further appreciated by a person skilled in the art that high-voltage and low-voltage switches 270 may be controlled by 150 power conversion controller or by a separate switch controller (not shown in the drawings). Moreover, high-voltage and low-voltage switches 270 may also be configured to be controlled by a user of bidirectional power converter described herein.

A detailed description of the components of bidirectional power converter 200b will now be provided.

FIG. 3 schematically illustrates a circuit diagram of grid interface 225 of the power converter 200b illustrated in FIG. 2B, further connected to grid protection components. Each terminal L1 and L2 may be connected in series with a fuse 304a and 304b, respectively. Placing a fuse in series with each terminal of the AC power source may provide overcurrent protection for power converter 200b, which may help protect power converter 200b from catching fire. Also, fuses 304a and 304b may help to protect the power source, i.e., split-phase AC power mains, and the conductors feeding into the power supply, when bidirectional power converter 200b operates in an inverter mode. For reasons of protection, there may not be any other circuit components between the fuse and the conductors from the AC power source, so when fuses 304a and 304b open, this may stop the current flow through a corresponding circuit branch of power converter 200b. It may be appreciated by the person skilled in the art that fuses 304a and 304b may be selected based upon the voltage, current, response time and operating temperature of the other circuit components of power converter 200b.

As further schematically illustrated in FIG. 3, metal oxide varistors (MOVs) 312a, 312b, 312c may be placed across the AC input terminals L1, L2, and neutral N, respectively, i.e., between terminals 344a and 344d, 344b and 344d, 344c and 344d, allowing to absorb voltage transients which may be provided by the split-phase AC mains power source, such as, for example, transient energy from lightning strikes, or other damage from the AC power network. MOVs 312a, 312b, and 312c may be high impedance during their normal operation and become low impedance when the rated voltage is exceeded, as would happen when an input transient voltage is present. It may be appreciated by a person skilled in the art that each MOV 312a, 312b may be connected in series with a fuse 304a, 304b, respectively, which may allow a fuse to open if a corresponding MOV goes low impedance due to a transient input voltage. It may be appreciated that MOVs may be selected based on the operating voltage of the power supply. It may also be appreciated that alternative protection components to a MOV may be, for example, transient voltage suppression (TVS) or a diode.

Furthermore, in this embodiment, gas discharge tube (GDT) 314 may be connected in series with MOVs 312a, 312b, and 312c, i.e., between terminals 344d and 346b, which may also be used as additional surge protection.

Moreover, current sensors 306a and 306b may be used for monitoring the ripple in the electrical current flowing through live wires L1 and L2, respectively, ensuring power quality (PQ) control. Furthermore, ground fault detection (GFD) device 308, which may be connected to live wires L1, L2 and neutral N, may be used to determine if there exists a fault condition if the current imbalance may appear in live wires L1 and L2.

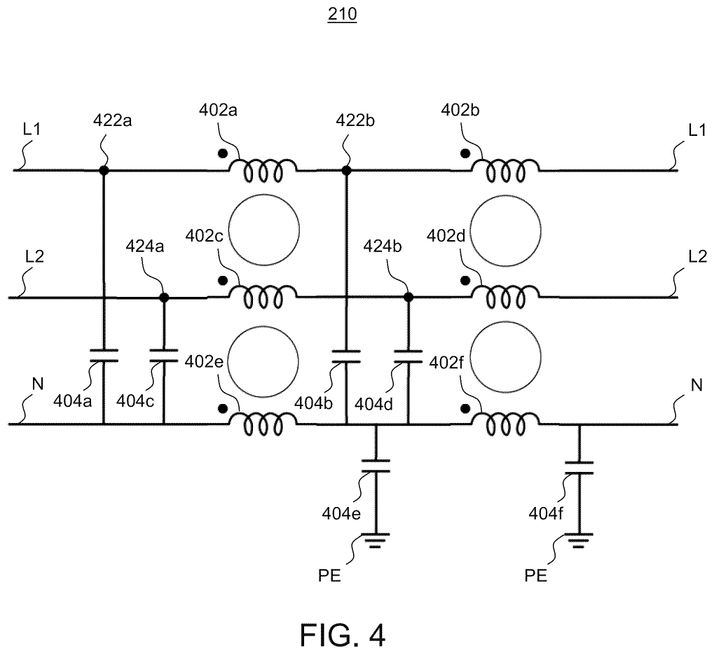

FIG. 4 schematically illustrates an electrical circuit diagram of an EMI filter 210, which may comprise two common mode inductors 402a, 402b placed in series with the live wire L1, two inductors 402c, 402d placed in series with the live wire L2, and two inductors 402e, 402f placed in series with the neutral wire N. Furthermore, inductors 402a, 402c, and 402e, as well as inductors 402b, 402d, and 402f, may be magnetically coupled, i.e., wound on the same magnetic core, which may be made of ferromagnetic material, such as, for example, iron or ferrite, providing a common mode choke, allowing them to filter out high-frequency noise, which may be present on live wires L1 and L2, while allowing the desired AC signal to pass through. It may be appreciated by a person skilled in the art that any other suitable EMI filter may be used in place of the EMI filter 210.

As further schematically illustrated in FIG. 4, EMI filter 210 may also comprise two capacitors 404a and 404b, each of which may be connected between the live wire L1 and the neutral N (i.e., between terminal 422a and N, and between terminal 422b and N, respectively), and two capacitors 404c and 404d, each of which may be connected between the live wire L2 and the neutral N (i.e., between terminal 424a and N, and between terminal 424b and N, respectively). It may be appreciated that capacitors 404a, 404b, 404c, and 404d may be connected in parallel and may filter the differential-mode noise, i.e., the noise which may be present between two conductors, such as, in this case, the live and neutral AC lines. Furthermore, two capacitors 404e and 404f may be connected between the neutral wire N and the ground (PE). It may be appreciated that capacitors 404e and 404f may be connected in parallel and may filter the common mode noise.

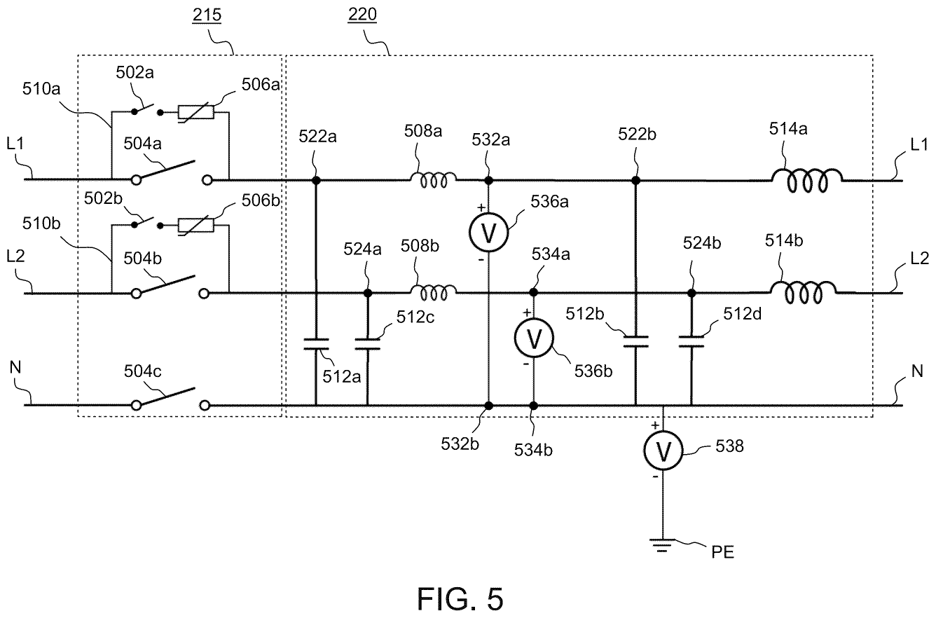

As further schematically illustrated in FIG. 5, EMI filter 210 may be further connected to AC relays 215. AC relay 510a/510b associated with each live wire L1, L2, respectively, may comprise pre-charge contactors 502a, 502b, which may be connected in series with thermistors 506a, 506b, respectively. Furthermore, AC relay 510a/510b may comprise main contactor 504a/504b, which may be placed on the live wire L1/L2 and may be connected in parallel to pre-charge contactor 502a/502b and thermistor 506a/506b, respectively. Furthermore, main contactor 504c may be placed on a neutral wire N. It may be appreciated by the person skilled in the art that, when EV charger operates in the rectifier mode, closing the pre-charge contactors 502a/502b of the AC relays 510a/510b, respectively, would allow to the current flow through the resistors 506a/506b, which, in turn, may reduce the inrush of current to the capacitors of the further connected AC-to-DC LCL filter 220, allowing them to charge slowly, avoiding inrush current spikes.

As further illustrated in FIG. 5, AC-to-DC LCL filter 220, which may be connected to AC relays 215, may comprise capacitors 512a and 512b, which may be connected between the live wire L1 and neutral N, i.e., between the terminal 522a and N, as well as between the terminal 522b and N, respectively. AC-to-DC LCL filter 220 may also comprise capacitors 512c and 512d, which may be connected between the live wire L2 and neutral N, i.e., between terminal 524a and N, as well as between terminal 524b and N, respectively. The circuit of AC-to-DC LCL filter 220 may further comprise inductors 508a and 514a, which may be placed in series with live wire L1, i.e., both inductors 508a and 514a may be connected to terminal 522b, and inductors 508b and 514b, which may be placed in series with live wire L2, i.e., both inductors 508b and 514b may be connected to terminal 524b. It may be appreciated that inductors 514a and 514b may have a greater inductance than inductors 508a and 508b. Therefore, inductor 508a, capacitor 512b, and inductor 514a, as well as inductor 508b, capacitor 512d, and inductor 514b, may form LCL filters of AC-to-DC LCL filter 220, allowing for attenuation of high-frequency harmonics in the AC traveling through live wires L1 and L2, respectively. For example, when bidirectional power converter 200b operates as an inverter, AC-to-DC LCL filter 220 would prevent the noise from propagating into a user's home or back into AC mains. It may be appreciated by a person skilled in the art that any other suitable AC-to-DC LCL filter may be used instead or in combination with AC-to-DC LCL filter 220.

Moreover, voltage sensor 536a may be connected between terminals 532a and 532b, and voltage sensor 536b may be connected between terminals 534a and 534b, allowing for the measurement of the potential difference between the live wire L1 and neutral wire N, as well as the live wire L2 and N, respectively. Furthermore, voltage sensor 538 may be connected between the neutral wire N and the protective ground (PE), in order to ensure the safety of the electrical system.

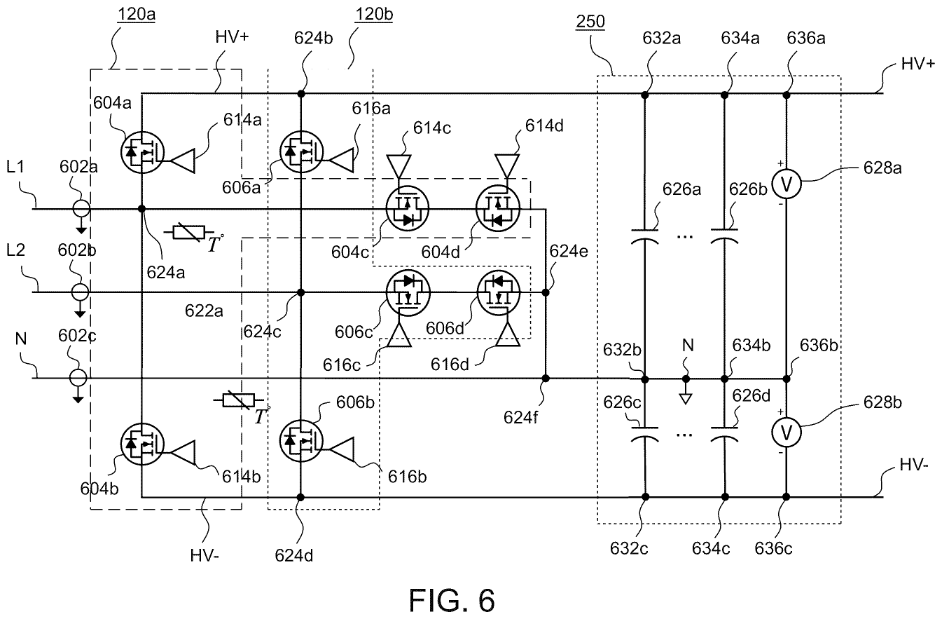

As further schematically illustrated in FIG. 6, AC-to-DC LCL filter 220 may further be connected to AC-to-DC converters 120a and 120b, which may, in this example, have the T-type topology and may be used to convert the AC voltage into multi-level DC voltage or vice versa. It may be appreciated that switch 604a may be connected to the live wire L1 and positive high-voltage line HV+, i.e., between terminals 624a and 632a, switch 604b may be connected to the live wire L1 and negative high-voltage line HV−, i.e., between terminals 624a and 634c. Furthermore, switches 604c and 604d may be placed in series with the live wire L1 and may further be connected to neutral N, i.e., between terminals 624c and 624f. It may be appreciated that switches 604a, 604b, 604c, and 604d may form a first single-bridge leg of AC-to-DC converter 120a associated, for example, with the live wire L1.

It may further be appreciated that switch 606a may be connected between the live wire L2 and positive high-voltage line HV+, i.e., between terminals 624c and 632a, switch 606b may be connected between the live wire L2 and negative high-voltage line HV−, i.e., between terminals 624c and 632c. Furthermore, switches 606c and 606b may be placed in series with the live wire L2 and may further be connected to neutral N, i.e., between terminals 624c and 624e, which may further be connected to neutral wire N through terminal 624f. It may be appreciated that switches 606a, 606b, 606c, and 606d may form a second single-bridge leg of AC-to-DC converter 120b associated, for example, with the live wire L2.

It may be appreciated that switches 604a, 604b, 604c, and 604d of AC-to-DC converter 120a and switches 606a, 606b, 606c, and 606d of AC-to-DC converter 120a current may be controlled by power conversion controller 150, for allowing the current to flow to a correct branch. Moreover, the above-mentioned switches may be provided by IGBT, MOSFET, SiC, or any other suitable switches. As an example, SiC FETS switches are illustrated in FIG. 6. It may be appreciated that switches 604a, 604b, 604c, and 604d may comprise gate inputs 614a, 614b, 614c and 614d, respectively, and switches 606a, 606b, 606c, and 606d may comprise gate inputs 616a, 616b, 616c, and 616d, respectively, in order to control the switch states.

It may further be appreciated by a person skilled in the art that current sensors 602a, 602b, and 602c may be placed on the live wires L1, L2 and neutral wire N, respectively, for monitoring the ripple in the electrical current.

As further schematically illustrated in FIG. 6, AC-to-DC converters 120a and 120b may be further connected to DC-bus capacitors 250 through positive (high-voltage) DC terminal 624b and negative (high-voltage) DC terminal 624b, respectively, as well as neutral terminal 624f. A capacitor 626a may be connected in parallel with at least one capacitor 626b, wherein capacitor 626a may be connected between positive high-voltage line HV+ and neutral wire N, i.e., between terminals 632a and 632b, and capacitor 626b may be connected between positive high-voltage line HV+ and neutral wire N, i.e., between terminals 634a and 634b. Furthermore, a capacitor 626c may be connected in parallel with at least one capacitor 626d, wherein capacitor 626c may be connected between negative high-voltage line HV− and neutral wire N, i.e., between terminals 632b and 632c, and a capacitor 626d may be connected between negative high-voltage line HV− and neutral N, i.e., between terminals 634b and 634c. It may be appreciated that capacitors 626a and 626c, as well as at least one capacitor 626b and at least one capacitor 626d, may be connected in series.

Moreover, voltage sensor 628a may be connected between the positive high-voltage line HV+ and neutral wire N, i.e., between terminals 636a and 636b, and voltage sensor 628b may be connected between the negative high-voltage line HV− and neutral wire N, i.e., between terminals 636b and 636c, allowing to measure the potential difference between HV+ and N, and HV− and N, respectively.

As further schematically illustrated in FIG. 7A, DC-link and bus capacitors 250 may further be connected to an EV isolated DC-to-DC power converter 125, which may be provided by bidirectional dual-active-bridge (DAB) DC-to-DC power converter, offering galvanic isolation, which may be provided by high-frequency isolation transformer 235. In this example, high-frequency isolation transformer 235 may have one primary winding 716a and two secondary windings 716b and 716c. Furthermore, DC-to-DC power converter 125 may comprise primary side 710a having DC to high-frequency AC converter 230 connected to primary winding 716a of isolation transformer 235, allowing for converting DC to high-frequency AC, and secondary side 710b having first high-frequency AC-to-DC converter, which may be connected to first secondary winding 716b of isolation transformer 235 and second high-frequency AC-to-DC converter, which may be connected to second secondary winding 716c of isolation transformer 235, i.e., allowing for converting high-frequency AC to DC.

It may be appreciated that a DC to high-frequency AC converter 230 may be connected to DC-link and bus capacitors 250 on a DC side, i.e., through terminals 750a and 750b, respectively. Current sensor 742a may be placed on the negative high-voltage line HV− for effective monitoring of the total current on primary side 710a by providing more stable and low-noise point to measure the current, therefore, leading to cleaner data for control algorithms and allowing for precise feedback control, ensuring that the controller operates within safe limits. It may be appreciated that a pair of series-connected capacitors 720a and 720b, which may be connected between terminals 750a and 750b, may constitute a part of DC bus capacitors 250. Furthermore, it may be appreciated that DC to high-frequency AC converter 230, when working in inverter mode, may provide AC current having a frequency from about 90 kHz to about 150 kHz.

As illustrated in FIG. 7A, primary side 710a of DC-to-DC power converter 125 may further comprise capacitor 732, which may be provided by a flying capacitor and may be connected in parallel to DC bus capacitors 720a and 720b between the positive high-voltage line HV+and the negative high-voltage line HV−, i.e., between terminals 752a and 752b; a pair of series-connected switches 702a and 702b, and a pair of series-connected switches 704a and 704b, wherein each pair of switches may be connected in parallel between HV+ and HV−, i.e., between terminals 754a and 754b. It may be appreciated that switches 702a and 704b, and switches 702b and 704a may be complementary. Primary winding 716a of the high-frequency isolation transformer 235 may be connected between terminals 754c and 756a. Furthermore, leakage inductor 712 may be connected in series with primary inductor 716a of high-frequency isolation transformer 235 between terminals 754c and 756a. It may be appreciated by a person skilled in the art that leakage inductor 712 may constitute a part of isolation transformer 235. Moreover, inductor 758 may be connected between terminals 750a and 772a, and voltage sensor 774a may be connected between terminals 772a and 772b.

Secondary side 710b of DC-to-DC power converter 125 may comprise first high-frequency AC to DC converter 240a and second high-frequency AC to DC converter 240b (as schematically illustrated, for example, in FIG. 2B). It may be appreciated that first AC-to-DC converter 240a may be connected to first secondary winding 716b of high-frequency transformer 235, i.e., between terminals 756b and 762c, and second AC-to-DC converter 240b may be connected to second secondary winding of high-frequency transformer 235, i.e., between terminals 756c and 762f.

As further illustrated in FIG. 7A, first AC-to-DC converter 240a may comprise a pair of series-connected switches 722a and 722b, and a pair of series-connected switches 724a and 724b, wherein each pair of switches may be connected in parallel between HV+ and HV−, i.e., between terminals 762a and 762b. It may be appreciated that switches 722a and 724b, and switches 722b and 724a may constitute a first plurality of switches associated with first high-frequency AC to DC converter 240a and may be complementary. Second AC-to-DC converter 240b may comprise a pair of series-connected switches 722c and 722d, and a pair of series-connected switches 724c and 724d, wherein each pair of switches may be connected in parallel between HV+ and HV, i.e., between terminals 762d and 762e. It may be appreciated that switches 722c and 724d, and switches 722d and 724c may may constitute a second plurality of switches associated with second high-frequency AC to DC converter 240b and may be complementary.

It may also be appreciated that the above-mentioned switches of DC-to-DC power converter 125 may be provided, for example, by silicon carbide (SiC) switches or any other suitable switches. As illustrated example, IGBT switches are shown in FIGS. 7A and 7B. It may be appreciated that switches 702a, 702b, 704a and 704b of DC to high-frequency AC converter 230 may comprise gate inputs 706a, 706b, 708a and 708b, respectively; switches 722a, 722b, 724a, and 724b of first high-frequency AC to DC converter 240a may comprise gate inputs 726a, 726b, 728a, 728b, respectively; switches 722c, 722d, 724c, 724d of second high-frequency AC to DC converter 240b may comprise gate inputs 726c, 726d, 728c, 728d, respectively.

Furthermore, first high-frequency AC to DC converter 240a of secondary side 710b may comprise capacitor 734a, which may be connected in parallel to switches 722a and 722b, and switches 724a and 724b, i.e., between the positive high-voltage line HV+and negative high-voltage line HV− (i.e., between terminals 764a and 764b). Also, second high-frequency AC to DC converter 240b of secondary side 710b may comprise capacitor 734b, which may be connected in parallel to switches 722c and 722d, and switches 724c, and 724d, i.e., between the positive high-voltage line HV+ and negative high-voltage line HV− (i.e., between terminals 764c and 764d).

Moreover, for second high-frequency AC to DC converter 240b, voltage sensor 774b may be connected between the positive high-voltage line HV+ and negative high-voltage line HV−, i.e., between terminals 772c and 772d. Also, for secondary side 710b, voltage sensor 774c may be connected between the positive high-voltage line HV+ and negative high-voltage line HV−, i.e., between terminals 772e and 772f.

It may further be appreciated that secondary side 710b may comprise control switches 270a, 270b, and 270c, which may allow for first high-frequency AC to DC converter 240a and second high-frequency AC to DC converter 240b to be connected either in parallel or in series. It may be appreciated that first switch 270a may be connected between terminals 766a and 766b, and plurality of second switches 270b and 270c may be connected between terminals 770a and 766b, 766b and 770b, respectively. For example, it may be appreciated by a person skilled in the art that when switches 270b and 270c are closed and switch 770a is open, both first and second high-frequency AC to DC converters 240a and 240b may operate in parallel. Furthermore, when switches 770b and 770c are open and switch 770a is closed, both first and second high-frequency AC to DC converters 240a and 240b may operate in series, which may provide a high-voltage DC output. For example, when each one of first and second high-frequency AC to DC converters 240a and 240b of isolated DC-to-DC power converter 125 may be capable of outputting between 300 V to 500 V DC, connecting them in series may provide DC output between 600 V to 1000 V DC at maximum current value, which may be used to fast charge EV battery 180 (see, for example, FIG. 2B).

As further illustrated in FIG. 7A, inductor 776a may be placed in series with the positive high-voltage line HV+, i.e., between terminals 772e and 782a, and inductor 776b may be placed in series with the negative high-voltage line HV−, i.e., 772f and 782b. Furthermore, capacitor 738 may be connected between the positive high-voltage line HV+ and negative high-voltage line HV−, i.e., between terminals 782a and 782b.

Furthermore, current sensors 742b, 742c, and 742d which may be provided by galvanically isolated Hall-effect sensors or any other suitable current sensors such as shunt current sensors with an isolated amplifier, may be placed in series with primary winding 716a, first secondary winding 716b, and second secondary winding 716c, respectively, for measuring the current of isolation transformer 235 on primary side 710a and secondary side 710b, respectively. Furthermore, current sensors 742e and 742f may be placed in series with HV− line of DC side of first and second high-frequency AC to DC converters 240a and 240b, respectively. It may be appreciated that sensors 742a, 742b, 742c, 742d, 742e, and 742f may provide an overcurrent protection for each pair of switches of DC-to-DC power converter 125 by providing real-time current feedback to power conversion controller 150, which is critical for implementing advanced modulation schemes, e.g., phase-shift control, as well as maintaining a power flow between primary side 710a and secondary side 710b. The accurate current feedback may allow DC-to-DC power converter 125 to adjust the duty cycles and switching phases for optimal power transfer and efficiency.

Alternatively, FIG. 7B schematically illustrates DC-to-DC power conversion controller 125 which may allow for connecting high-frequency AC to DC converter 240a to first EV battery 180a and high-frequency AC to DC converter 240b to second EV battery 180b (as illustrated in FIG. 2E). In this example of circuit configuration, a plurality of third switches 270d, 270e, and 270i may be connected between terminals 770a and 772c, 770c and 772d, 766a and 770c, respectively, and a plurality of fourth switches 270f, 270g, and 270h may be connected between terminals 770d and 772e, 770b and 772f, 766d and 770d, respectively. Therefore, in this example, isolated DC-to-DC power converter 125 may either charge one EV battery or two EV batteries simultaneously (as described for FIG. 2E).

For example, when both EV batteries 180a and 180b are connected to bidirectional power converter 200c, and a user wants to charge both batteries simultaneously, power conversion controller 150 may close switches 270d, 270e, and 270i, as well as switches 270f, 270g, and 270h, while switches 270a, 270b, and 270c may remain open. This would allow to output up to 600 V DC to each EV battery simultaneously. Furthermore, while first and second EV batteries 180a, 180b are connected to bidirectional power converter 200c, power conversion controller 150 may decide to first charge one EV battery and then charge the other one based on charge voltage commands received from BMS 170a and BMS 170b of EV batteries 180a and 180b, respectively.

It may be appreciated that in an embodiment of DC-to-DC power converter 125 illustrated in FIG. 7B, voltage sensor 774c may be connected between terminals 772e and 772f, and voltage sensor 774b may be connected between terminals 772c and 772d. Furthermore, inductors 776a and 776c may be connected between terminals 772c and 782a, 772d and 782c, respectively. Also, inductors 776d and 776b may be connected between terminals 772e and 782d, 772f and 782b, respectively. It may further be appreciated that capacitors 738 and 736 may be connected between terminals 782a and 782c, and 782d and 782b, respectively.

Furthermore, when first and second high-frequency AC to DC converters 240a and 240b are connected in parallel, both of them may supply between 300 V to 500 V DC at double of the maximum current value. In this case, when one of AC to DC converters 240a and 240b fails, the other one may continue supplying power, so that bidirectional power converter 200b keeps running adding redundancy as well as allowing lower output current ripple if they are operated with some phase shift. Also, it may be appreciated that instead of one converter of AC to DC converters 240a and 240b handling all current, the load is shared, which may help keeping each converter cooler.

It may further be appreciated by a person skilled in the art that it may be possible to charge or discharge EV battery 180 using only one of first and second high-frequency AC to DC converters 240a and 240b. For example, closing switch 270c may allow the current to flow through first high-frequency AC to DC converter 240a, while second high-frequency AC to DC coveter 240b may be at rest. Likewise, closing switch 270b may allow the current to flow through second high-frequency AC to DC converter 240b, while first high-frequency AC to DC coveter 240a may be at rest. In this case, it may be appreciated that each one of first and second high-frequency AC to DC converter 240a and 240b may be capable of supplying between 300 V to 500 V DC to EV battery 180a or 180b (see FIG. 2C). This functionality of secondary side 710b of isolated DC-to-DC power converter 125 may, for example, may help slowing down the wear out of first and second high-frequency AC to DC converters 240a and 240b. Also, in case one of two AC-to-DC converters 240a or 240b fails, the other one, which remain operational will allow a user to still use bidirectional power converter provided in diagram 200b of FIG. 2B.

In an alternative embodiment schematically illustrated in FIG. 7C, isolated DC-to-DC power converter 125 may have isolation transformer 235 having one primary winding 716a and one secondary winding 716b. It may further be appreciated that primary side 710a of isolated DC-to-DC power converter 125 may comprise the components of primary side 710a of isolated DC-to-DC power converter 125 shown in FIGS. 7A and 7B. However, it may be appreciated that voltage sensor 774a may be connected at primary winding 716a of isolation transformer 235, i.e., between terminals 772a and 772b.

As further illustrated in FIG. 7C, secondary side 710b′ may be similar to secondary side 710b shown in FIGS. 7A and 7B corresponding to only one high-frequency AC to DC converter 240a/240b, in order to capture an embodiment of bidirectional power converter 200a illustrated in FIG. 2A. It will further be appreiciated that current sensors 742c may be connected between terminals 756b and 762c, and current sensor 742d may be connected between terminals 772b and 782b.

Furthermore, DC-to-DC power converter 125 may be connected to EV DC EMC, protection and pre-charge circuit 275 schematically illustrated in FIG. 8, i.e., through terminals 832a and 832b. It may be appreciated, EV DC EMC, protection and pre-charge circuit 275 may comprise EMI filter 810, protection circuit 820, and pre-charge circuit 830.

It may be appreciated by a person skilled in the art that, as schematically illustrated in FIG. 2C, each one of first and second high-frequency AC to DC converters 240a and 240b may be connected to a separate EV DC EMC, protection and pre-charge circuits 275 (i.e., to corresponding EV DC EMC, protection and pre-charge circuits 275a and 275b, respectively). For example, HV+ and HV− lines of one EV DC EMC protection and pre-charge circuit 275 may be connected to terminals 782a, 782b of isolated DC-to-DC converter 125 illustrated in FIG. 7A, or to terminals 782a, 782c (i.e., for EV DC EMC protection and pre-charge circuit 275a) and to terminals 782d, 782b (i.e., for EV DC EMC protection and pre-charge circuit 275a) of isolated DC-to-DC converter 125 illustrated in FIG. 7B. This may allow to use first high-frequency AC to DC converter 240a for charging or discharging EV battery 180a, and to use second high-frequency AC to DC converter 240b for charging or discharging EV battery 180b.

EMI filter 810 may comprise capacitors 802a and 802b, which may be connected in series between positive high-voltage line HV+and negative high-voltage line HV−, i.e., between terminals 832a and 832c, and to ground (PE) at midpoint provided by terminal 832b. It may be appreciated that capacitor 802a may be connected between positive high-voltage line HV+ and neutral wire N, i.e., between terminals 832a and 832b, and capacitor 802b may be connected between negative high-voltage line HV− and neutral wire N, i.e., between terminals 832b and 832c. Furthermore, EMI filter 810 may comprise inductor 806a, which may be connected between terminals 832a and 834a, and inductor 806b, which may be connected between terminals 832c and 834b. It may be appreciated that inductors 806a, 806b may be magnetically coupled and share the same magnetic core, which may be made of ferromagnetic material, such as, for example, iron or ferrite. It may further be appreciated that magnetically coupled inductors 806a, 806b may serve a purpose of a common mode choke, allowing to handle the maximum current flow and have acceptable power dissipation during normal operation of the bidirectional power converter, and create high impedance to attenuate common mode currents flowing along the input conductors.

Also, EMI filter 810 may further comprise capacitor 808, which may be connected in parallel with capacitors 802a, 802b, and capacitors 804a, 804b between positive high-voltage line HV+and negative high-voltage line HV−, i.e., between terminals 834a, 834b. It may be appreciated by the person skilled in the art that capacitor 808, which may be placed across positive high-voltage line HV+ and negative high-voltage line HV−, may be used to shunt differential conducted voltage noise, so the latter does not propagate further.

As shown in FIG. 8, protection circuit 820 of EV DC EMC protection and pre-charge circuit 275 may comprise MOV 812, which may be connected between positive high-voltage line HV+ and negative high-voltage line HV−, in parallel with capacitor 808, i.e., between terminals 836a, 836b. Furthermore, protection circuit 820 may comprise fuse 814, which may be placed in series with positive high-voltage line HV+, i.e., between terminals 836a and 838a.

As further illustrated in FIG. 8, pre-charge circuit 830 of EV DC EMC protection and pre-charge circuit 275 on a positive high-voltage side HV+ may comprise main positive contactor 822a, which may be placed in series with positive high-voltage line HV+, pre-charge contactor 816a, which may be connected in parallel with main positive contactor 822a, and pre-charge resistor 818a, which may be connected in series with pre-charge contactor 816a and connected in parallel with main positive contactor 822a.

Furthermore, pre-charge circuit 830 of EV DC EMC protection and pre-charge circuit 275 on a negative high-voltage side HV− may comprise main negative contactor 822b, which may be placed in series with negative high-voltage line HV−, pre-charge contactor 816b, which may be connected in parallel with main negative contactor 822b, and pre-charge resistor 818b, which may be connected in series with pre-charge contactor 816b and connected in parallel with main negative contactor 822b.

Pre-charge circuit 830 may further be followed by at least one resistor 826, which may be connected in series between positive high-voltage line HV+ and negative high-voltage line HV−, i.e., between terminals 844a and 844b, to provide voltage discharge. Furthermore, EV isolation monitor 850, for monitoring EV DC voltage, may further be connected to positive high-voltage line HV+ at terminal 846a and negative high-voltage line HV− at terminal 846b, as well as to PE, which may allow to monitor the entire circuit that leads to the battery of an EV. EV isolation monitors 850 may be used to measure the output DC voltage and voltage to PE, as well as to measure the resistance between HV+, HV− and PE, in order to detect a ground fault, protecting both an EV user and a power conversion circuit. Furthermore, voltage sensor 852 may be connected between terminals 848a and 848b, allowing to measure the voltage on EV terminals 860a and 860b, which may further be connected to EV battery 180.

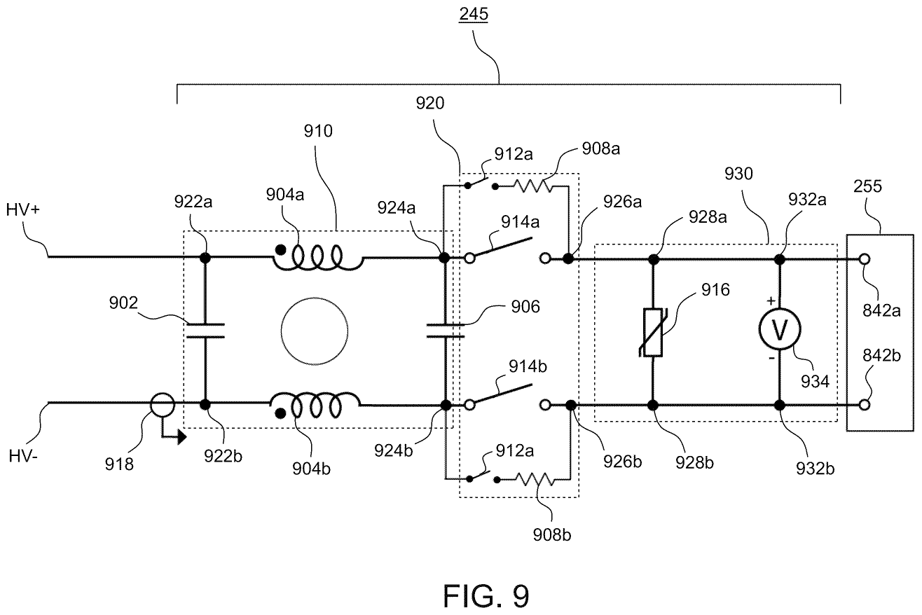

FIG. 9 schematically illustrates photovoltaic (PV) electromagnetic compatibility (EMC), protection and pre-charge circuit 245 comprising EMI filter 910, pre-charge circuit 920, and protection circuit 930. The EMI filter 910 may comprise capacitor 902, which may be connected across positive high-voltage line HV+ and negative high-voltage line HV−, i.e., between terminals 922a, 922b, respectively; inductor 904a, which may be placed in series with positive high-voltage line HV+, i.e., between terminals 922a and 924a, and inductor 904b may be placed in series with negative high-voltage line HV, i.e., between terminals 922b and 924b; and capacitor 906, which may be connected across positive high-voltage line HV+ and negative high-voltage line HV−, i.e., in parallel to capacitor 902, i.e., between terminals 924a and 924b. It may be appreciated that inductors 904a, 904b may be magnetically coupled and share the same magnetic core, which may be made of ferromagnetic material, such as, for example, iron or ferrite. It may further be appreciated that magnetically coupled inductors 806a, 806b may serve a purpose of a common mode choke and create high impedance to attenuate common mode currents flowing along the conductors. It may be appreciated that a current sensor 918 may be placed on the negative high-voltage line HV− for measuring the total current on the output side of PV EMC, protection and pre-charge circuit 245.

As further schematically illustrated in FIG. 9, pre-charge circuit 920, on the positive high-voltage side HV+may comprise main positive contactor 914a, which may be placed in series with positive high-voltage line HV+, i.e., between terminals 924a and 926a, pre-charge contactor 912a, which may be connected in parallel with main positive contactor 914a, and a pre-charge resistor 908a, which may be connected in series with pre-charge contactor 912a and connected in parallel with main positive contactor 914a. Furthermore, pre-charge circuit 920, on the negative high-voltage side HV− may comprise main negative contactor 914b, which may be placed in series with negative high-voltage line HV−, i.e., between terminals 924b and 926b, pre-charge contactor 912b, which may be connected in parallel with main negative contactor 914b, and pre-charge resistor 908b, which may be connected in series with pre-charge contactor 912b and connected in parallel with main negative contactor 914b.

As further illustrated in FIG. 9, pre-charge circuit 920 may be connected to protection circuit 930, which may comprise MOV 916 connected across positive high-voltage line HV+ and negative high-voltage line HV−, i.e., between terminals 928a and 928b. Also, voltage sensor 924 may be connected between terminals 932a and 932b, in parallel with MOV 916, for measuring the total output voltage between positive and negative PV outputs 842a and 842b of PV panel array 255, respectively.

It may be appreciated by a person skilled in the art that PV panel array 255 may be controlled by power electronics and control systems designed to optimize energy generation and delivery, such, as for example PV DC optimizers 253 (see FIG. 2B). The amount of power produced by each PV panel of PV panel array 255 may vary depending on the internal and/or external conditions, e.g., environmental conditions, PV material, heat distribution, etc. Therefore, each PV panel or a group PV of panels, which exhibit similar behavior under certain conditions (for example, produce about the same amount of power on a sunny day), may be operated using a separate controller, which may comprise maximum power point tracking (MPPT) algorithms, which may allow to ensure that a PV panel operates at its optimal power point under varying environmental conditions (e.g., even under suboptimal conditions, such as partial shading, temperature changes, or non-ideal sunlight). For large PV panel arrays, certain systems dynamically reconfigure the series-parallel arrangements of panels to match environmental conditions and load requirements. More precisely, each controller may collect data from sensors (e.g., voltage, current, irradiance, and temperature sensors connected to a PV panel), which may allow to dynamically adjust operating parameters of each panel and achieve maximum efficiency.

It may further be appreciated by a person skilled in the art that each PV panel of PV panel array 255 may have a non-linear power-voltage characteristic curve, which is influenced by irradiance (sunlight intensity) and temperature. In this case, MPP is the point on the curve where the corresponding PV panel produces maximum power, wherein MPP varies dynamically depending on the environmental changes. Thus, PV panel controllers may continuously monitor the voltage and current output of each panel of PV panel array to find its MPP. It is known by a person skilled in the art that algorithms like Perturb and Observe (P&O), Incremental Conductance, Hill Climbing, etc., may be used to adjust the panel's operating voltage to achieve MPP. MPPT may adjust load impedance dynamically, ensuring that the operating point matches MPP, which may maximize the energy extracted, especially under changing conditions like irradiance reduced by cloud cover and temperature fluctuation affecting panel efficiency.

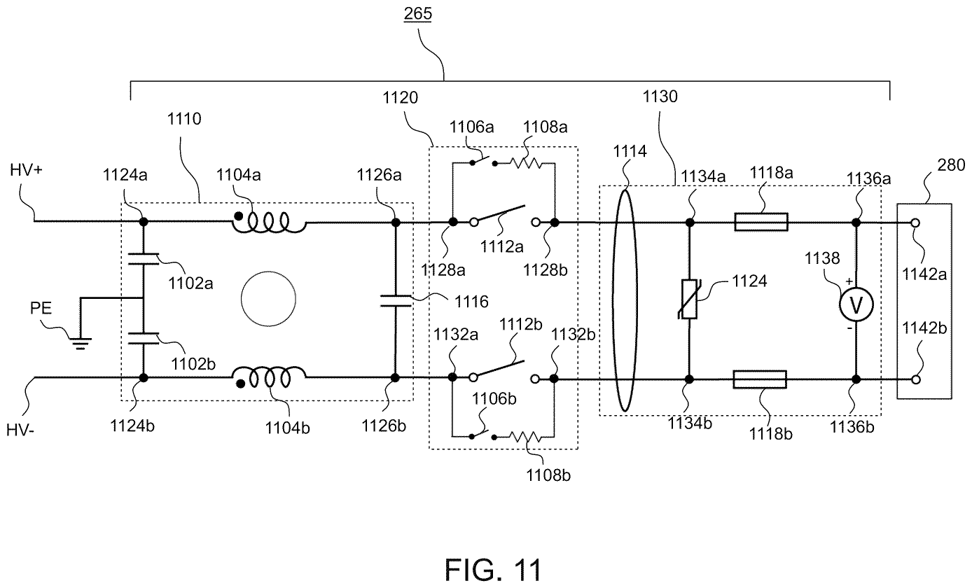

Coming back to FIG. 9, in this embodiment, while the power produced by PV panel array 255 may be controlled using an MPPT algorithm to maximize the energy extracted from the PV panels, PV panel array 255 may further be connected directly to DC bus capacitors 250. More specifically, the power generated by a PV panel array may be supplied to DC bus capacitors 250 without first passing through a DC-to-DC power converter. In this case, the voltage of DC bus capacitors 250 may be adjusted by power conversion controller 150 to be lower than the output voltage of PV panel array 255, allowing to create the voltage difference, which is fundamental for power flow in an electrical circuit and, therefore, allows for the power flow from the PV panel array to DC bus capacitors 250. It may be appreciated that DC bus capacitors 250 may accept as much power as is available from the PV panels, and use such power for supplying AC power, charging the EV or the storage battery. If more power is required to, for example, charge the battery of an EV, then DC bus capacitors 250 may draw additional power, for example, from the split-phase mains or from an external storage battery 280 (see, for instance, FIG. 11).

It may be further appreciated by a person skilled in the art that power conversion controller 150 may receive from PV DC power optimizers 253 an available DC voltage value and DC current value to further estimate an available DC power, which may be provided by PV panel array 255. This data may then be used to dynamically adjust voltage-power droop curve and frequency-power droop curve, which may allow for further adjustment of the power transfer from PV panel array 255 based on demand of DC bus capacitors 250, while ensuring stability of the microgrid.

In an alternative embodiment, it may be appreciated that a DC-to-DC power converter (not shown in the drawings) may be connected between DC bus capacitors 250 and PV panel array 255, allowing to boost DC produced by PV panels.

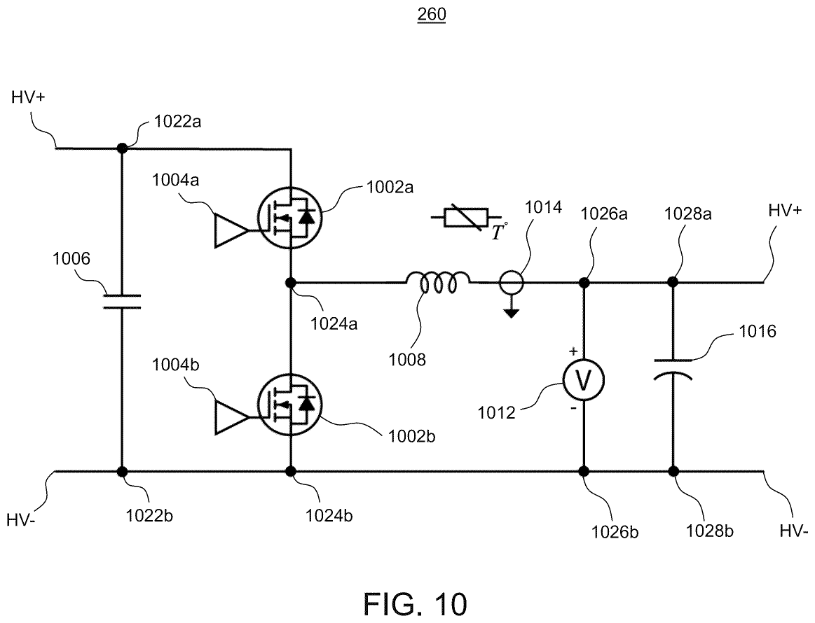

FIG. 10 schematically illustrates a third ESS DC-to-DC power converter 260 of the BESS. The third ESS DC-to-DC power converter 260 may comprise a capacitor 1006, which may be connected across positive high-voltage line HV+ and negative high-voltage line HV−, i.e., between terminals 1022a and 1022b; a pair of switches 1002a and 1002b, wherein switch 1002a may be placed in series with positive high-voltage line HV+, i.e., between terminals 1022a and 1024a, and switch 1002b may be placed in series with negative high-voltage line HV−, i.e., between terminals 1022b and 1024a; inductor 1008, which may be placed in series with positive high-voltage line HV+, i.e., between terminals 1024a and 1026a; voltage sensor 1012, which may be connected across positive high-voltage line HV+ and negative high-voltage line HV−, i.e., between terminals 1026a and 1026b; and capacitor 1016, which may be connected in parallel with switches 1002a and 1002b, i.e., between terminals 1028a and 1028b.

The third ESS DC-to-DC power converter 260 of the BESS may further be connected to BESS EMC, protection and pre-charge circuit 265, which is schematically illustrated in FIG. 11. BESS EMC, protection and pre-charge circuit 265 may comprise EMI filter 1110, pre-charge circuit 1120, and protection circuit 1130. The EMI filter 1110 may comprise capacitor 1102a, which may be connected between positive high-voltage line HV+ and the ground (PE), and capacitor 1102b, which may be connected between negative high-voltage line HV− and the ground (PE). Inductor 1104a may be connected in series with capacitor 1102a, i.e., between terminals 1124a and 1126a, and inductor 1104b may be connected in series with capacitor 1102b, i.e., between terminals 1124b and 1126b. Furthermore, capacitor 1116 may be connected between terminals 1126a, 1126b, in parallel with capacitors 1102a, 1102b. It may be appreciated that inductors 1004a and 1004b may be magnetically coupled, i.e., wound on the same magnetic core, which may be made of ferromagnetic material, such as, for example, iron or ferrite, forming a common mode choke.

As further illustrated in FIG. 11, pre-charge circuit 1120 on the positive high-voltage side HV+ may comprise main positive contactor 1112a, which may be placed in series with positive high-voltage line HV+, i.e., between terminals 1128a and 1128b, pre-charge contactor 1106a, which may be connected in parallel with main positive contactor 1112a, and pre-charge resistor 1108a, which may be connected in series with pre-charge contactor 1106a and connected in parallel with main positive contactor 1112a. Furthermore, pre-charge circuit 1120 on the negative high-voltage side HV− may comprise main negative contactor 1112b, which may be placed in series with negative high-voltage line HV−, i.e., between terminals 1132a and 1132b, pre-charge contactor 1106b, which may be connected in parallel with main negative contactor 1112b, and pre-charge resistor 1108b, which may be connected in series with pre-charge contactor 1106b and connected in parallel with main negative contactor 1112b.

Protection circuit 1130 may comprise ground fault circuit interrupter (GFCI) 1114 may be connected to pre-charge circuit 1120. MOV 1124 may be placed across positive high-voltage line HV+ and negative high-voltage line HV−, i.e., between terminals 1134a and 1134b. Furthermore, fuse 1118a may be placed in series with positive high-voltage line HV+ and MOV 1124, i.e., between terminals 1134a and 1136a, and fuse 1118b may be placed in series with negative high-voltage line HV− and MOV 1124, i.e., between terminals 1134b and 1136b. Moreover, voltage sensor 1138 may be connected EV power terminals, i.e., to positive DC terminal 1142a and the negative DC terminal 1142b of EV battery 180, for measuring the total output voltage of the EV battery.

What is claimed is:

1. A bidirectional power converter for converting electric power between an AC power grid and an electric vehicle (EV), the system comprising:
at least one AC-to-DC power converter having an AC port and a DC side port;
an isolated DC-to-DC power converter connected on a first side to said DC side port of said at least one AC-to-DC power converter and on a second side to a first and a second pair of DC terminals, the at least one isolated DC-to-DC power converter comprising:
an isolation transformer having a primary winding and two secondary windings;
a DC to high-frequency AC converter connected to the DC side of the at least one AC-to-DC power converter and to the primary winding of the isolation transformer on an AC side;
a first high-frequency AC to DC converter connected to a first one of said two secondary windings on the AC side and to the first pair of DC terminals on the DC side; and
a second high-frequency AC to DC converter connected to a second one of said two secondary windings on said AC side and to the second pair of DC terminals on the DC side; and
a power conversion controller having an interface for receiving a charge command from a battery management system (BMS) of an electric power storage battery of the EV, a grid tie phase and a voltage measurement, said power conversion controller operatively connected to the at least one AC-to-DC power converter and to the isolated DC-to-DC power converter for transferring power in accordance with the charge voltage command, the grid tie phase and the voltage measurement.

2. The bidirectional power converter as defined in claim 1, wherein said at least one AC-to-DC power converter comprises a first AC-to-DC power converter and a second AC-to-DC power converter, wherein the AC side port of the first AC-to-DC power converter and the AC side port of the second AC-to-DC power converter are connected to a respective phase of the AC power grid and connected together at a midpoint or neutral.

3. The bidirectional power converter as defined in claim 1, further comprising:
at least one first switch for connecting said first pair of DC terminals and said second pair of DC terminals in series for providing a single high-voltage DC EV connection; and
a plurality of second switches for connecting said first pair of DC terminals and said second pair of DC terminals in parallel for providing a low-voltage DC EV connection.

4. The bidirectional power converter as defined in claim 3, wherein said plurality of second switches are arranged to selectively connect to one of two EVs for providing a low-voltage DC connection to one EV, or to two EVs for providing a low-voltage DC connection to two EVs.

5. The bidirectional power converter as defined in claim 3, wherein the at least one first switch and the plurality of second switches are controlled by the power conversion controller with respect to the charge voltage command of the BMS of the electric power storage battery for providing a controlled DC output to said EV connection.

6. The bidirectional power converter as defined in claim 2, wherein the respective phase comprises a first AC output and a second AC output that are 180 degrees out of phase, wherein the first AC output is connected to the AC port of the first AC-to-DC power converter, and the second AC output is connected to the AC port of the second AC-to-DC power converter.

7. The bidirectional power converter as defined in claim 3, wherein the high-voltage DC output is between 600 V DC and 1000 V DC.

8. The bidirectional power converter as defined in claim 3, wherein the low-voltage DC output is preferably between 300 V DC and 500 V DC.

9. An electric vehicle (EV) charger, the charger comprising:
an isolated DC-to-DC power converter connected on a first side to said DC side port of said at least one AC-to-DC power converter and on a second side to a first and a second pair of DC terminals, the isolated DC-to-DC power converter comprising:
an isolation transformer having a primary winding and two secondary windings;
a DC to high-frequency AC converter connected to the DC side of the at least one AC-to-DC power converter and to the primary winding of the isolation transformer on an AC side;
a first high-frequency AC to DC converter connected to a first one of said two secondary windings on the AC side and to the first pair of DC terminals on the DC side; and
a second high-frequency AC to DC converter connected to a second one of said two secondary windings on said AC side and to the second pair of DC terminals on the DC side; and
a power conversion controller having an interface for receiving a charge command from a battery management system (BMS) of an electric power storage battery of the EV, said power conversion controller operatively connected to the isolated DC-to-DC power converter for transferring power in accordance with the charge command.

10. The EV charger as defined in claim 9, further comprising:
at least one first switch for connecting said first pair of DC terminals and said second pair of DC terminals in series for providing a single high-voltage DC EV connection; and
a plurality of second switches for connecting said first pair of DC terminals and said second pair of DC terminals in parallel for providing a low-voltage DC EV connection.

11. The EV charger as defined in claim 10, wherein said plurality of second switches are arranged to selectively connect to one of two EVs for providing a low-voltage DC connection to one EV, or to two EVs for providing a low-voltage DC connection to two EVs.
